(19) United States
(12) Patent Application Publication
(10) Pub. No.: US 2025/0066589 A1
(43) Pub. Date: Feb. 27, 2025

(54) IMPROVED BIOCHAR REINFORCED RUBBER

(71) Applicants: Constantine KHRIPIN, Greenville, SC (US); COMPAGNIE GENERALE DES ETABLISSEMENTS MICHELIN, Clermont-Ferrand (FR)

(72) Inventors: Constantine KHRIPIN, Simpsonville, SC (US); Marie-Josee DUMONT, Quebec (CA); Jiby Kudakasseril KURIAN, Quebec (CA)

(21) Appl. No.: 18/725,203

(22) PCT Filed: Dec. 31, 2021
(86) PCT No.: PCT/US2021/065829

§ 371 Date: Jun. 28, 2024

(51) Int. Cl. C08K 11/00; B60C 1/00

(52) U.S. Cl. CPC C08K 11/00; B60C 1/00; C08K 2201/005

(57) ABSTRACT

An environmentally friendly rubber filler of biochar particles having a low ash content, combined with a low nitrogen content is disclosed herein. The biochar when used as a rubber filler results in a composition that exhibits surprisingly improved properties including excellent tensile properties. The properties of the rubber composition are observed to be further improved when the biochar is comprised of particles less than 0.4 μm diameter.

### BACKGROUND OF THE INVENTION

There is an ever-growing demand by consumers for environmentally friendly products resulting in manufacturers seeking the use of more renewable materials in the manufacturing of new products with improved sustainability. In the case of tires and other products formed of cured elastomeric compositions, a major component is the filler. Currently, these fillers include silica and carbon black, both of which are derived from non-renewable sources. Production of carbon black results in the release of 3 kg of CO2, in addition to nitrous and sulfurous pollutants for each kg of carbon black produced. No commercially available fillers match carbon black's performance as a filler and improve sustainability.

Previous work in the area of environmentally friendly fillers has resulted in carbon blacks synthesized from biochar, which is obtained by the pyrolysis of biomass. U.S. Pat. No. 10,927,304 describes biochar made of hemp pyrolyzed at a temperature greater than 600° C. and ground to be added to rubber. Unfortunately, the resulting filer was not fine enough to match the properties delivered by carbon black reinforcement. In another publication by Xiao et al., a biochar was created using ground bone, although no use was described as a filler for rubber. Xiao, J., R. Hu, and G. Chen, Micro-Nano-Engineered Nitrogenous Bone Biochar Developed With a Ball-Milling Technique for High-Efficiency Removal of Aquatic Cd (II), Cu (II) And Pb (II). Journal of Hazardous Materials, 2020. 387: p. 121980. Other references described grinding birchwood biochar for use in SBR. Peterson, S. C., S. R. Chandrasekaran, and B. K. Sharma, Birchwood Biochar as Partial Carbon Black Replacement in Styrene-Butadiene Rubber Composites. Journal of Elastomers & Plastics, 2016. 48(4): p. 305-316. Another reference described using heat treated starch to cover the biochar to enhance the properties by purportedly making it more hydrophobic. Peterson, S. C. and S. Kim, Using Heat-Treated Starch to Modify the Surface of Biochar and Improve the Tensile Properties of Biochar-Filled Styrene-Butadiene Rubber Composites. Journal of Elastomers & Plastics, 2019. 51(1): p. 26-35. These advances, while they moved the field of renewable rubber fillers ahead, did not deliver a filler which could match the properties of carbon black in rubber.

As such, it has recently been demonstrated that biochar from pine wood, corn stover and other sources can be used to reinforce rubber compositions, provided that (a) a suitable solvent is used in grinding, for example ethanol and (b) a proton-acceptor covering agent is used to block the biochar pores, for example DPG as described in Patent Publication WO2021138444A1. What has not been determined is what sort of biochar is optimal for use in rubber.

A need exists to identify fillers and methods to produce them which can be produced from renewable sources and whose properties approach that of carbon black. Such fillers may be used in the manufacture of tires and tire components, such as bead fillers, gum strips, skim stock for the formation of belt and carcass layers reinforced with elongate textile or metal reinforcements, as well as the manufacture of other elastomeric products, such as conveyor belts, gaskets, tractor treads, for example.

As noted above, there is a desire to use renewable materials in the manufacture of products and to develop fillers derived from renewable sources for the manufacture of elastomeric products. Accordingly, the resulting sub-micron ground biochar may be used in any elastomeric composition (either in the form of a cured composition or as a mixture for forming the cured composition) as a complete substitute for any non-renewable filler, such as carbon black and silica, for example, such that the elastomeric composition is free of any non-renewable filler, such as carbon black and silica. In other instances, the sub-micron ground biochar may be used with reduced amounts of any such non-renewable fillers to form an elastomeric composition. Any such elastomeric composition using the sub-micron ground biochar contemplated herein may be used for any elastomeric product utilizing elastomeric compositions that must be cured (that is, vulcanized), such as any tire tread or other tire component, gasket, conveyor belt, etc.

The elastomeric composition, such as natural or synthetic rubber, for example, using renewable sources as described and contemplated herein utilizes biochar as a filler. Biochar, which is also referred to as pyrolyzed biomass, may be formed using any biomass, such as wood (e.g., pine wood and wood residue), corn stover, wheat straw, oat hulls, rice husk, manure, switchgrass, miscanthus, lignin, and bamboo, for example. The selection of the type and combination of biomass that can be utilized for biochar is nearly infinite. Using biochar as a filler in elastomeric compositions has been hindered by various problems and it has been observed that the selection of the biomass affects its suitability as a rubber filler.

For example, as-synthesized biochar consists of particles comprised of carbon, plus additional minerals or “ash”. It has been observed that low ash concentrations in the biochar are desirable for useful properties in the biochar composites, and low ash biochar results favorable properties in the rubber composition when used as a filler compared to biochar containing higher ash content. Peterson, S. C., Utilization of low-ash biochar to partially replace carbon black in styrene-butadiene rubber composites. Journal of Elastomers & Plastics, 2013. 45(5): p. 487-497. However, the inventors have discovered that ash content is not the primary determinant in the properties and is inadequate to fully explain the resulting properties. A biochar selection criterion to select the appropriate biochar feedstock is needed to achieve optimal elastomer properties.

### SUMMARY OF THE INVENTION

Aspects and advantages of the invention will be set forth in part in the following description, or may be obvious from the description, or may be learned through practice of the invention.

In one exemplary embodiment, an environmentally friendly biochar is disclosed having less than 15% ash content and less than 5% elemental nitrogen content.

In another exemplary embodiment, a curable elastomeric composition for use in a cured elastomeric product is disclosed containing an elastomer, 1 to 200 phr of a biochar filler formed of a particulate and one or more curatives, wherein the biochar filler contains less than 15% ash and less than 5% elemental nitrogen.

In yet another exemplary embodiment in accordance with either of the previous two embodiments wherein the biochar filler contains less than 5% ash and less than 1% elemental nitrogen.

In yet another exemplary embodiment in accordance with either of the first two embodiments wherein biochar filler contains less than 3% ash and less than 0.5% elemental nitrogen.

In another exemplary embodiment in accordance with any of the embodiments discussed above wherein a majority of the particulate is sized less than 0.5 micron. In another exemplary embodiment in accordance with any of the previous embodiments wherein more than 90% of the particulate is sized less than 0.5 micron. In yet another exemplary embodiment elastomeric composition of any one of the above claims wherein 99% of the particulate is less than one micron.

In yet another embodiment in accordance with any of the embodiments discussed above wherein the particulate size of the ground biochar is greater than 0.1 micron.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a plot of the tensile modulus of rubber prepared with different types of biochar filler.

The use of identical or similar reference numerals in different figures denotes identical or similar features.

### DETAILED DESCRIPTION OF THE INVENTION

The inventors have discovered that biochar particles having a low ash content, combined with a low nitrogen content and used as a filler in an elastomeric compound exhibit surprisingly improved properties. Additionally, the properties are observed to be better when the biochar is comprised of particles less than 0.4 μm (micron) diameter. Additionally, it has been observed that the properties are improved while using a grinding method in ethanol.

For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

Biochar Preparation and Pyrolysis. The biochar is prepared by selecting a biomass feedstock then desiccating by warming the biomass to remove water. Then the biomass is then pulverized to reduce the particle size. The pulverized biomass is pyrolyzed in an oxygen deprived atmosphere and allowed to cool. The resulting biochar is passed through a screen to obtain fine biochar particles.

In the embodiments and examples herein, biochar was prepared by selecting the biomass feedstock then drying the feedstock in an oven to remove moisture from the feedstock. The moisture was considered “removed” when a constant mass is obtained over time after being placed in an oven at 105° C., indicating that the moisture has been removed. It is appreciated that other methods may be used to remove the water, including, for example, placing the biochar in an oven heated to 150° C. for two hours. The biomass was then pulverized to 2 mm or smaller sized particles in preparation for pyrolysis by use of a soil grinder to obtain the desired particle size. It should be noted that any suitable grinder may be used. Pyrolysis was accomplished under a nitrogen blanket at 700° C. for one hour. In the examples described herein, pyrolysis was achieved by placing 50 g of desiccated biomass feedstock was placed into steel tubes and pyrolyzed under a 0.5 L/min nitrogen flow at 700° C. for one hour. The pyrolyzed biochar was allowed to cool to room temperature (approximately 22° C.) before being passed through a 425 μm sieve.

Grinding of Biochar. The biochar particles are then ground in a solvent and allowed to dry. This is accomplished by further grinding the particles and passed through a 100 μm size sieve. The particles are then ground in a solvent using spherical media in an agitated media mill and dried.

In the embodiments and examples herein, the biochar having a particle size of 100 μm or larger was ground using a conical bur mill. The biochar was passed through a 100 μm sieve and 15 g of which was placed into a 500 cc stainless steel milling jar with 750 g of 1 mm diameter ceramic beads (YSZ media) and 60 g of ethanol solvent. The biochar was ground in a ball mill for 6 hours, reversing directions halfway through. The biochar was then separated from the milling media and allowed to dry.

Other grinding fluids may be used. In particular instances, the grinding fluid is substantially a solvent. For example, the solvent may be an alcohol, such as ethanol, methanol, or isopropanol, for example. In other variations, the solvent may be toluene, acetone, or water. The grinding fluid may be provided as necessary to achieve a desired biochar particle size, and in certain instances, the grinding fluid is provided as a ratio of grinding fluid mass to biochar mass of 2:1 to 15:1.

Particular embodiments of such methods may optionally include pre-grinding the biochar composition if the biochar particulate is greater than 10% in size relative to the milling media until the biochar composition particulate is equal to or less than 10% in size relative to the milling media.

Particular embodiments of this disclosure include a curable elastomeric composition for use in a cured elastomeric product or a cured elastomeric product itself, either such composition including an elastomer and 1 to 200 phr or more of biochar filler formed of particulate, where a majority of the particulate is less than 1 micrometer. One or more curatives may also be included. In other variations, 5 to 50 phr is employed. Optionally, in certain embodiments, the curable or cured elastomeric composition is free of any non-renewable filler.

It is appreciated that any grinding contemplated herein may be performed using any desired process or apparatus to reduce the particle size of the biochar. For example, in certain instances, grinding is performed by way of a milling operation using any known mill, such as a conical mill, planetary ball mill, agitated media mill, or hammermill, for example. By further example, grinding may be performed using a sonicator or high shear mixer in solvent but without grinding media, or in other variations with grinding media but without solvent.

Passivating agents may be added as described in patent application publication PCT/US2020/067499.

It is appreciated that the particle size of biochar may be determined using any known method or apparatus. For example, disc centrifuge photosedimentometry (DCP), density gradient particle sedimentation, laser light scattering (dynamic or static), or light diffraction techniques may be used to determine the particle size of biochar dispersed in water, such as particle size analyzers produced by Malvern Panalytical (e.g., Mastersizer). The number average may be employed to define an average particle size. By further example, an image analysis may be performed, such as by taking an SEM (scanning electron microscope) image at high voltage, 10 kV (kilovolts), and high magnification, such as 2,000-10,000×, produce a high resolution image of the particles, with which particle sizing and counting can be performed (automatically or manually). In particular instances, the particle size measurements may be taken according to the following method, even with regard to determining post-grinding effects. Of note, the particle sized discussed herein may be obtained using the following method, and where such particle sizes were measured herein, the following method was employed. The cured elastomeric composition was cut with a Teflon coated razor blade to create a bulk sample. The sample was imaged using SEM at a high voltage (10 kV) to reveal the individual filler grains as opposed to the composite surface. The images were analyzed using the program ImageJ. First, two copies of the image were created: one filtered with a fine scale filter (0.05 μm radius gaussian blur) and one filtered with a coarse scale filter (1 μm radius). The coarse filtered image was subtracted from the fine filtered image to reveal the particles. The “Make Binary” function was used to create a binary image of the particles, and the “Analyze Particles” function with the “Fit Ellipse” measurement enabled was used to catalogue the particles. Particle diameters were calculated by averaging the major and minor axes of the fitted ellipses.

### Rubber Composition Formulation

The formulations used for the mixes containing the test biochars are given in Table 1. Standard mixing and milling procedures were used to prepare the rubber.

TABLE 1
Formulations used in this study.

| Name | Amount in Biochar Mix (phr) | Amount in CB Mix (phr) |
|---|---|---|
| Elastomers | | |
| SBR 2300 | 100 | 100 |
| Fillers | | |
| N772 | 0 | 50 |
| Biochar | 55 | 0 |
| Chemicals | | |
| 6PPD | 2 | 2 |
| DPG | 2 | 0 |
| ZnO | 2 | 2 |
| SAD | 3.2 | 1.2 |
| Curatives | | |
| S | 1.5 | 1.5 |
| CBS | 3 | 1.5 |

Test Sample Preparation. Rubber samples were cured to >95% of the maximum modulus. The rubber was cured in 2.5 mm sheets and 75 mm dogbone samples were punched from the cured 2.5 mm rubber sheets for tensile testing. The tensile properties were measured using an Instron 5966 Extensometer at 23° C. in accordance with ASTM Standard D412 on ASTM C test pieces.

### Results

A number of feedstocks were examined to determine the impact of nitrogen content and ash content. The feedstocks are described in

Table 2. The feedstocks, and resulting biochars, mainly vary in two main respects: ash content and nitrogen content. In terms of ash content, biochar prepared from cow manure feedstock is highest, followed by chicken feather, corn stover, canola protein, pine wood, lignin and corn starch. In terms of nitrogen content, Canola protein is highest, followed closely by chicken feather, with corn starch being much lower.

TABLE 2
The properties of organic feedstocks and biochar prepared from same.

| | Feedstock Composition | | | | Pyrolysis | Biochar Composition | | | |
|---|---|---|---|---|---|---|---|---|---|
| | Ash % | N % | O % | C % | T, ° C. | Ash % | N % | O % | C % |
| Canola | 2.58 ± 0.62 | 14.4 ± 0.1 | 27.0 ± 0.4 | 47.2 ± 0.1 | 700 C., | 10.08 ± 0.49 | 11.3 ± 0.2 | 7.32 ± 0.52 | 66.9 ± 0.9 |
| Protein | | | | | 1 h | | | | |
| Corn | Trace | Trace | 48.83 | 43.74 | 700 C., | 0.34 ± 0.60 | 0.24 ± 0.01 | 12.10 ± 0.30 | 78.90 ± 0.80 |
| Starch [9] | | | | | 1 h | | | | |
| Softwood | 0.96 ± 0.12 | 0.0[10] | 28.2[10] | 63.4[10] | 700 C., | 2.13 ± 0.35 | 0.69[11] | 23.85[11] | 70.98[11] |
| kraft | | | | | 1 h | | | | |
| Lignin | | | | | | | | | |
| Corn | 4.40 ± 0.83 | 0.56[12] | 39.7[12] | 46.5[12] | 700 C., | 13.53 ± 1.05 | 0.69[13] | 4.38[13] | 81.47[13] |
| Stover | | | | | 1 h | | | | |
| Chicken | 2.69 ± 0.45 | 13.30 ± 0.40 | 26.30 ± 0.20 | 48.00 ± 1.20 | 700 C., | 18.23 ± 1.96 | 9.48 ± 0.46 | 8.03 ± 0.74 | 61.90 ± 0.40 |
| Feather | | | | | 1 h | | | | |
| Pine | 0.79 ± 0.20 | 0.51[14] | 37.4[14] | 50.7[14] | 650 C., | 2.37 ± 0.52 | 0.48[14] | 14.0[14] | 63.8[14] |
| wood | | | | | 1 h | | | | |
| Cow | 15.28 ± 1.35 | 1.61 [17] | 27.73 | 36.62 | 700 C., | 29.75 ± 0.75 | 1.06 [17] | 5.84 [17] | 52.85 |
| manure | | | [17] | [17] | 1 h | | | | [17] |
| Cardboard | 1.54 ± 0.17 | 0.10 ± 0.01 [16] | 42.4 | 44.4 ± 2.2 [16] | 700 C., | 12.64 ± 1.12 | 0.17 ± 0.01 [16] | 18.27 [18] | 65.4 ± 3.3 [16] |
| | | | | | 1 h | | | | |

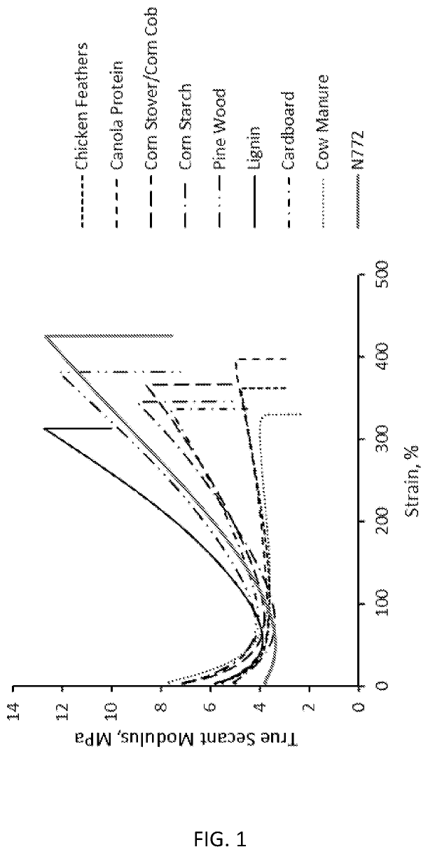

The tensile properties of rubber are important for performance of the finished product and are indicative of good coupling between the filler and the rubber. The true secant modulus of the samples is plotted in FIG. 1 and summarized in Table 3. The ratio E300/E100 is indicative of the strength of coupling between the filler and the rubber. A value of 1 indicates poor or no coupling. A value greater than 1.5 indicates good coupling. Likewise, the value E(break) indicates the tensile strength of the sample. A value below 5 indicates little reinforcement, while a value greater than 7 indicates sufficient reinforcement. The true secant modulus is measured as a function of the strain or elongation, that is to say, for a given elongation, the ratio of the extension stress, divided by the true cross section of the test specimen, to the elongation. Stated in the form of an equation, true secant modulus TSM=F*(1+strain)/A/strain, where F is the force and A is the initial cross-sectional area of the test specimen. The true secant modulus is expressed in MPa. Breaks are shown where the true secant modulus ceases to increase and immediately drops at a particular strain.

As noted above, it has been observed in the art that low ash concentrations in the biochar are desirable for useful properties in the biochar composites. However, we observe that ash content is not the primary determinant in the properties. Canola protein biochar (10% ash) is only slightly different from chicken feather biochar (18% ash) and cow manure (30% ash). Corn starch biochar (0.3% ash) is nearly identical to corn stover biochar (14% ash) and cardboard (13% ash) in ash content. Thus, low ash content is not the determining factor for good composite tensile properties. It may be advantageous, however, for other performances. The biochar samples shown in Table 3 demonstrate that the chemistry has a bigger impact than the ash content of the filler, which is a surprising result. It appears that carbohydrate fillers perform well, but not as well as the lignin rich pine wood and lignin proper. The nitrogen content appears to be the most impactful chemical variable. Canola protein differs from corn starch mainly in nitrogen content. The former is non-reinforcing while the latter performs well. Similarly, chicken feather differs from corn stover chiefly in nitrogen content. The corn stover performs well while chicken feather does not. Thus, the optimal feedstock would be biochar made from low-ash, high lignin, and low nitrogen feedstock having an ash content of less than 15% and a nitrogen content of less than 5%. Alternatively, the ash content should be less than 5% and the nitrogen content less than 1%. Better yet properties are to be expected when the biochar is selected with an ash content of less than 3% and an elemental nitrogen content of less than 0.5%.

TABLE 3
Summary of tensile properties of rubber prepared with various types of biochar and
the carbon black N772 as filler.

| | Chicken | Canola | Corn | Corn | Pine | | Card- | Cow | CB |
|---|---|---|---|---|---|---|---|---|---|
| | Feather | Protein | Stover/Cob | Starch | Wood | Lignin | board | dung | N772 |
| E(100%), MPa | 3.61 | 3.69 | 3.87 | 3.48 | 4.32 | 4.41 | 4.12 | 3.65 | 3.75 |
| E(300%), MPa | 4.42 | 4.44 | 7.04 | 7.58 | 9.29 | 12.08 | 6.93 | 3.99 | 8.86 |
| E300/E100 | 1.22 | 1.20 | 1.82 | 2.18 | 2.15 | 2.74 | 1.68 | 1.09 | 2.36 |
| E(break), MPa | 4.77 | 5.00 | 8.60 | 8.94 | 12.13 | 12.73 | 7.59 | 4.00 | 12.3 |
| e(break), % | 362 | 398 | 367 | 346 | 382 | 313 | 337 | 330 | 415 |

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

As used herein, the term “method” or “process” refers to one or more steps that may be performed in other ordering than shown without departing from the scope of the presently disclosed invention. Any sequence of steps is exemplary and is not intended to limit methods described herein to any particular sequence, nor is it intended to preclude adding steps, omitting steps, repeating steps, or performing steps simultaneously.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

1. A curable elastomeric composition for use in a cured elastomeric product, the composition comprising:
an elastomer;
1 to 200 phr of a biochar filler formed of a particulate; and
one or more curatives;
wherein the biochar filler contains less than 15% ash, and less than 5% elemental nitrogen.

2. The elastomeric composition of claim 1, wherein biochar filler contains less than 5% ash and less than 1% elemental nitrogen.

3. The elastomeric composition of claim 1, wherein biochar filler contains less than 3% ash and less than 0.5% elemental nitrogen.

4. The elastomeric composition of claim 1, where a majority of the particulate is sized less than 0.38 micron.

5. The elastomeric composition of claim 1, wherein more than 90% of the particulate is sized less than 1 micron.

6. The elastomeric composition of claim 1 wherein 99% of the particulate is less than two micron.

7. The elastomeric composition of claim 1 wherein the particulate size is greater than 0.1 micron.

8. A curable elastomeric composition for use in a cured elastomeric product, the composition comprising:
an elastomer;
1 to 200 phr of a biochar filler formed of a particulate; and
one or more curatives;
wherein the biochar filler contains less than 3% ash, and less than 0.5% elemental nitrogen.
wherein more than 90% of the particulate is sized less than 1 micron and
wherein more than 99% of the particulate is sized less than 2 micron.

9. A tire comprised of the rubber composition of claim 1.

10. The elastomeric composition of claim 8, where a majority of the particulate is sized less than 0.38 micron.

11. The elastomeric composition of claim 10, wherein more than 90% of the particulate is sized less than 1 micron.

12. The elastomeric composition of claim 11 wherein 99% of the particulate is less than two micron.

13. The elastomeric composition of claim 12 wherein the particulate size is greater than 0.1 micron.

14. A tire comprised of the rubber composition of claim 13.
